(19) United States
(12) Patent Application Publication
(10) Pub. No.: US 2015/0290876 A1
(43) Pub. Date: Oct. 15, 2015

(54) STEREOLITHOGRAPHIC APPARATUS AND METHOD

(71) Applicants: Yanjun Liu, Beijing (CN); Chengyu Jiang, Beijing (CN)

(72) Inventors: Yanjun Liu, Beijing (CN); Chengyu Jiang, Beijing (CN)

(21) Appl. No.: 14/733,972

(22) Filed: Jun. 9, 2015

(30) Foreign Application Priority Data
Apr. 9, 2014 (CN) 201410137959.X

(51) Int. Cl. B29C 67/00

(52) U.S. Cl. CPC B29C 67/0066; B29C 67/0088; B29K 2105/0058

(57) ABSTRACT

A stereolithographic apparatus and method is disclosed in the present invention. The stereolithographic apparatus includes a container for containing liquid photosensitive resin; an imaging means for displaying a contour of a two-dimensional image with a transparent region inside the contour; a light source device for projecting light onto a surface of the liquid photosensitive resin through the transparent region to cure the liquid photosensitive resin; wherein, the imaging means is disposed between the container and the light source device; the light source device is a area light source emitting substantially panel light.

### CROSS-REFERENCE TO RELATED APPLICATION

The present application claims the benefit of Chinese patent application number 201410137959.X, filed on Apr. 9, 2014, the disclosure of which is hereby incorporated by reference in its entirely.

### FIELD OF THE INVENTION

The present invention relates to rapid prototyping technology, and more particularly relates to a stereolithographic apparatus and method.

### DESCRIPTION OF THE RELATED ART

The rapid prototyping technology is a kind of advanced manufacturing technology, which is based on CAD (computer-aided-design) and CAM (computer-aided manufacturing) technology, laser technology, CNC (computer numerical control) technology, precision servo driving technology, new photo curing materials and so on. The rapid prototyping production technology is considered as a key technology of new products developments in manufacturing enterprises, which can promote product innovation, shorten the development cycle of new products and improve the competitiveness of products. The known rapid prototyping method includes stereo lithography appearance method, laminated object manufacturing method, selective laser sintering method, fused deposition modelling method, three dimension printing method, and solid ground curing method.

One of the most common rapid prototyping technologies is stereolithographic process. The principle of the stereolithographic process is that light source emits light through a transparent image displayed on the imaging means and project light onto the liquid photosensitive resin, the liquid photosensitive resin will solidify under exposure to the light based on the liquid photosensitive resin's light curing characteristic, and then a solid layer is formed. When one solid layer is built, scan remain resin for forming the next solid layer, and the new solid layer is fixed on the previous solid layer, repeat these steps to form a complete part. However, in the related art, the light source may be a point light source that emits stray light. The stray light will cure some liquid photosensitive resin that should not be cured.

### SUMMARY OF THE INVENTION

An objective of this application is to provide a stereolithographic apparatus and method, which is equipped with a area light source that emits substantially parallel light.

In one aspect, the present invention relates to a stereolithographic apparatus comprising a container for containing liquid photosensitive resin; an imaging means for displaying a contour of a two-dimensional image with a transparent region inside the contour; a light source device for projecting light onto a surface of the liquid photosensitive resin through the transparent region to cure the liquid photosensitive resin; wherein, the imaging means is disposed between the container and the light source device; the light source device is a area light source emitting substantially panel light.

In another aspect, the present invention relates to a stereolithographic method for producing an object having multiple cross-sections, the method comprising: step 1: filling a container with liquid photosensitive resin; step 2: displaying a contour of one of the cross-sections of the object on an imaging means with a transparent region inside the contour; step 3: projecting light onto a surface of the liquid photosensitive resin through the transparent region by a light source device, which is a area light source emitting substantially panel light, to cure the liquid photosensitive resin and convert it to a solid layer corresponding to the cross-section of the object; step 4: determining whether all of the cross-sections have been built, if all of the cross-sections have been built, the process completed; otherwise, executing the next step; step 5: lifting the previous solid layer, refilling the liquid photosensitive resin and repeating the steps 2-4 to form the object.

In yet another aspect, the present invention relates to a stereolithographic apparatus comprising: a vat for holding liquid curable resin; an imaging means for displaying a contour of a two-dimensional image with a transparent region inside the contour; a light source device for projecting light onto a surface of the liquid photosensitive resin through the transparent region to cure the liquid curable resin; an elevator means for raising and lowering the cured resin; a controlling unit for controlling the elevator means, the imaging means and the light source device to work; wherein, the imaging means is disposed between the vat and the light source device; the elevator means moves with respect to the vat; the controlling unit is electrically connected with the imaging means and the light source device; the light source device emits substantially parallel light.

### BRIEF DESCRIPTION OF THE DRAWINGS

For more clearly and easily understanding above content of the present invention, the following text will take a preferred embodiment of the present invention with reference to the accompanying drawings for detail description as follows. The drawings described herein are for illustration purposes only and are not intended to limit the scope of the present disclosure in any way.

FIG. 1 is a schematic view of a stereolithographic apparatus according to a first embodiment of the present invention.

FIG. 2 is a schematic view of a stereolithographic apparatus according to a second embodiment of the present invention.

FIG. 3 is a schematic view of a stereolithographic apparatus according to a third embodiment of the present invention.

FIG. 4 is a schematic view of a stereolithographic apparatus according to a fourth embodiment of the present invention.

FIG. 5 is a schematic view of a light source device of the stereolithographic apparatus according to the present invention.

FIG. 6 shows that an imaging means of the stereolithographic apparatus displays a contour of an object; a region inside the contour is transparent.

FIG. 7 is a schematic view of a light emitting unit of the light source device according to one embodiment of the present invention.

FIG. 8 is a schematic view of a light emitting unit of the light source device according to another embodiment of the present invention.

FIG. 9 is a schematic view of a light emitting unit of the light source device according to yet another embodiment of the present invention.

FIG. 10 is a schematic view of a light emitting unit of the light source device according to yet another embodiment of the present invention.

FIG. 11 is a flowchart of a stereolithographic method according to the present invention.

### DETAILED DESCRIPTION OF PREFERRED EMBODIMENTS

The embodiments of the present invention will be described in detail with reference to the accompanying drawings. It is intended that the present invention not be limited to the particular embodiment disclosed, but that the present invention will include all embodiments falling within the scope of the appended claims.

In the present disclosure, the term “area light source” is intended to mean that a light source emits substantially parallel light. In one embodiment of the present disclosure, “area light source” means that an emitter comprises a plurality of light emitting units distributed on a plane uniformly.

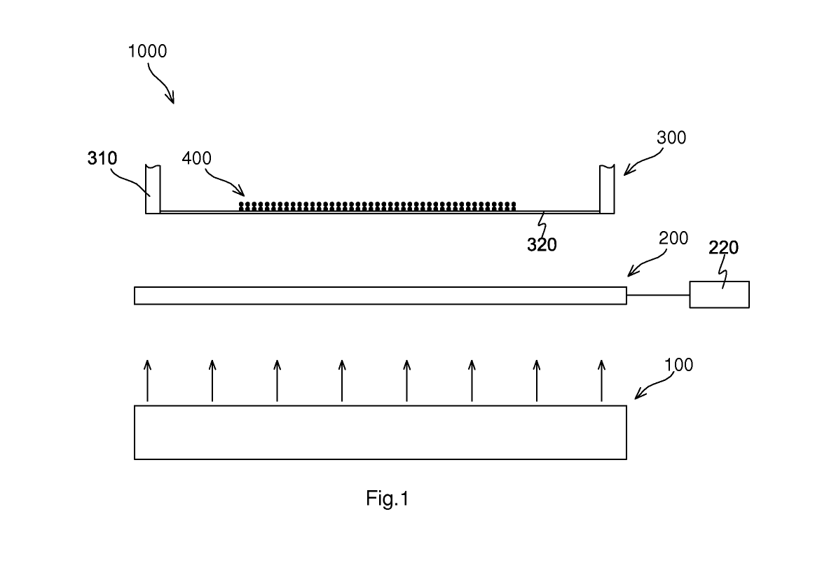

As shown in FIG. 1, in the first embodiment of the present disclosure, a stereolithographic apparatus 1000 includes a container 300 for containing liquid photosensitive resin 400, an imaging means 200 for displaying a contour of a two-dimensional image with a transparent region 240 inside the contour, and a light source device 100 for projecting light onto a surface of the liquid photosensitive resin 400 through the transparent region 240 to cure the liquid photosensitive resin 400 and convert it to a solid layer. In the embodiment, the light source device 100 is a area light source that can emit substantially parallel light. With such configuration of the stereolithgaphic apparatus, the uniform light emitted by the light source device 100 pass through the transparent region to cure the liquid photosensitive resin 400 based on the polymerization reaction, which can prevent the liquid photosensitive resin that should not be cured from curing.

When the stereolithographic apparatus 1000 is assembled, the light source device 100, the imaging means 200 and the container 300 are laminated in this order, which can provide a compact stereolighgaphic apparatus. The imaging means 200 is disposed between the light source device 100 and the container 300. The light emitted by the light source device 100 is projected onto the liquid photosensitive resin 400 in the container 300 through the imaging means 200.

The imaging means 200 is monochrome Thin Film Transistor Liquid Crystal Display (TFT-LCD) or colore TFT-LCD. TFT-LCD has following advantages: high speed, high brightness and high contrast. Alternatively, the imaging means 200 is not limited to this, and the imaging means 200 may be other kinds of LCD, such as Twisted Nematic LCD, Super Twisted Nematic LCD.

The imaging means 200 has a driving unit 220 for driving pixels of the imaging means 200 to display a contour of desired two-dimensional image. A transparent region is presented inside the contour. The light can pass through the transparent region. However, the light cannot pass through the region outside the contour.

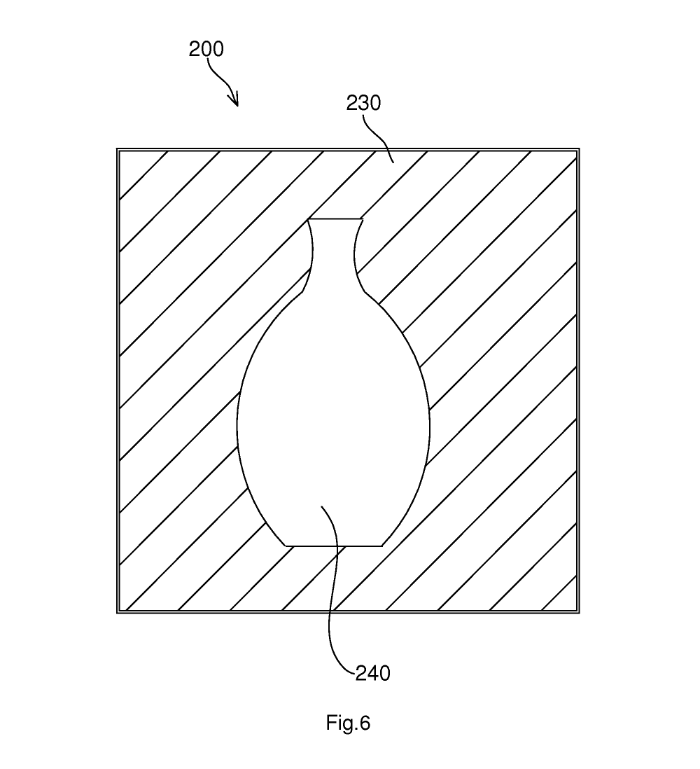

As shown in FIG. 6, when an object having a flower vase shape needs to be shaped, the driving unit 220 drives pixels of the imaging means 200 to display a contour of the flower vase shaped object (represented by two-dimensional image area 240). The two-dimensional image area 240 is transparent region which is inside the contour. The region outside the contour is lighttight region. The light source device 100 emits light through the transparent region 240 to cure the photosensitive resin 400 and form a layer with a flower vase shape.

As shown in FIG. 1, container 300 comprises a holder 310 and a transparent membrane 320 mounted on the holder 310. The transparent membrane 320 may be mounted on the holder 310 by normal means, such as adhesive, gluing, and so on. The transparent membrane 320 may be flexible transparent resin or hard glass. When assembled, the light source device 100, the imaging means 200 and the transparent membrane 320 are laminated in this order for providing a compact structure for the stereolithographic apparatus.

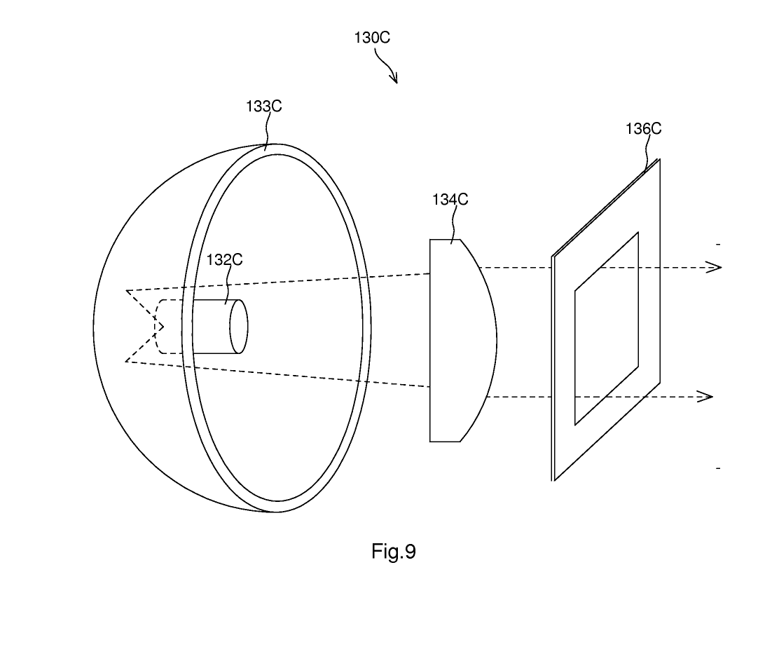

In this embodiment, the light source device 100 further comprises a light shading member 136C (as shown in FIG. 9) for absorbing stray light. With the configuration of light shading member 136C, a part of stray light is absorbed and shaded, which can prevent the liquid photosensitive resin that should not be cured from curing. The light shading member 136C may be disposed in the inner of a compartment 131 (see below). Alternatively, the light shading member 136C may be disposed outside the compartment 131.

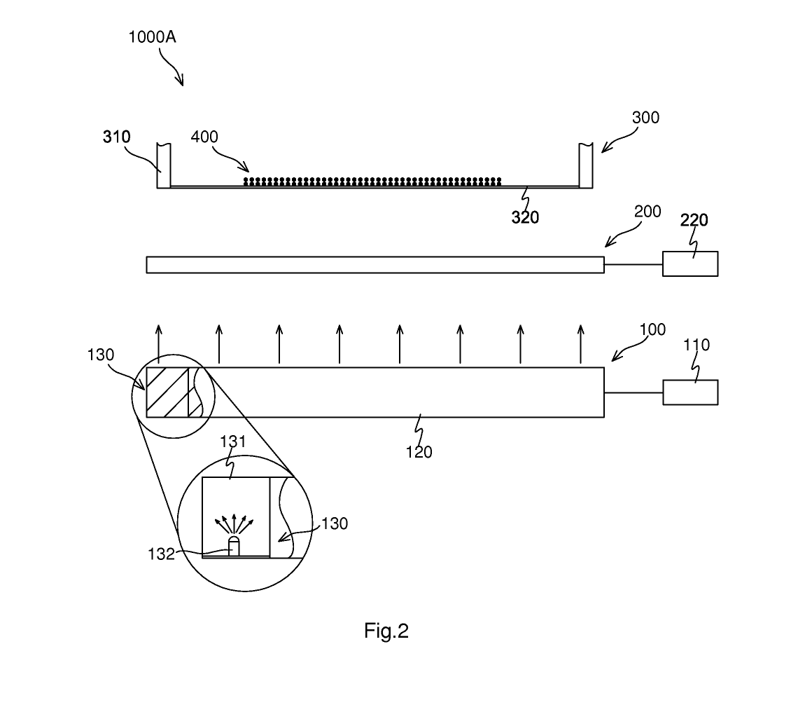

As shown in FIG. 2, which omits the same part shown in FIG. 1, in the second embodiment, the light source device 100 comprises a plurality of light emitting units 130 arranged in array. The number of the light emitting units 130 can be variable according to a shaping accuracy of the stereolithographic apparatus. The number of the light emitting units 130 is positively correlated with the shaping accuracy of the stereolithographic apparatus. In this embodiment, the number of light emitting units 130 may be above 100, preferably above 1000.

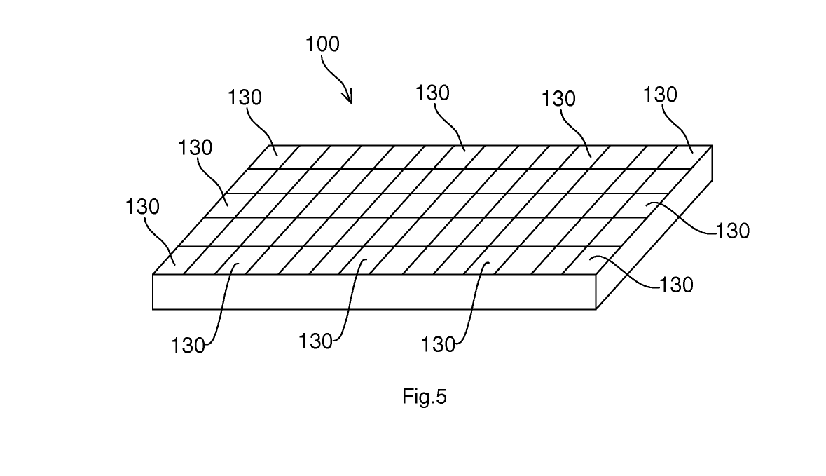

As shown in FIG. 2 and FIG. 5, the light source device 100 has a frame 120 including a plurality of compartments 131. The light emitting units 130 are formed in the compartments 131. The light emitting units 130 are arranged in a array with five rows and fourteen columns. Practically, the number of rows may be more than five and the number of columns may be more than fourteen.

In this embodiment, the light source device 100 further comprises a controller 110 electrically connected with the light emitting units 130 for controlling them to be on or off. The controller 110 can control each light emitting unit 130 to be on or off. With such configuration of the controller 110, the light emitting units 130 corresponding to the contour of the two-dimensional image displayed on the imaging means 200 are on. However, the light emitting units 130 located in a position corresponding to a region outside the contour are off. Thus, on one hand, the stray light can be reduced; on the other hand, the electric power can be saved.

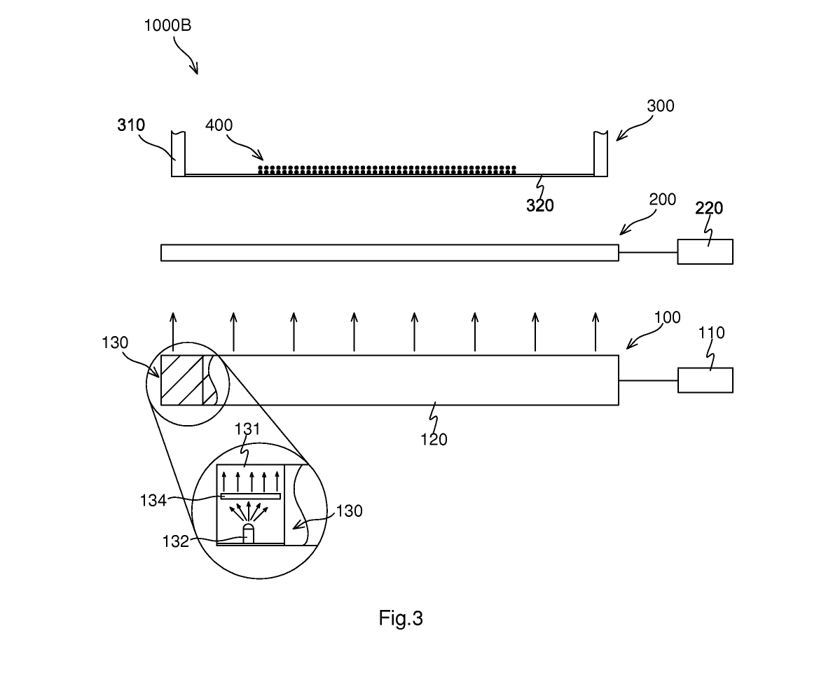

As shown in FIG. 3, which omits the same part shown in FIG. 2, in the third embodiment, each of the light emitting units 130 comprises at least one emitter 132 and a collimator 134. The term “collimator” refers to various elements or combinations thereof which can convert divergent light to substantially parallel light.

In this embodiment, the collimator 134 may be a reflector or a lens. For example, the collimator 134 may be a concave mirror or a spherical reflector. Alternatively, the collimator 134 may be a convex lens or a Fresnel lens. However, the collimator 134 is not limited to this; it may be other appropriate elements. By the configuration of collimator, it can effectively prevent the photosensitive resin that should not be cured from curing. In this embodiment, the emitter 132 and collimator 134 may be disposed in the compartment 131 of the frame 120. Alternatively, the collimator 134 may be disposed outside the compartment 131. Moreover, the inner walls of the compartments 131 may serve as collimators for converting divergent light to substantially parallel light, which can effectively solidify the resin and provide a compact apparatus. In this embodiment, one emitter 132 may correspond to one collimator 134. Alternatively, a multiple emitters 132 may correspond to one collimator 134, or, all of the emitters 132 may correspond to one collimator 134.

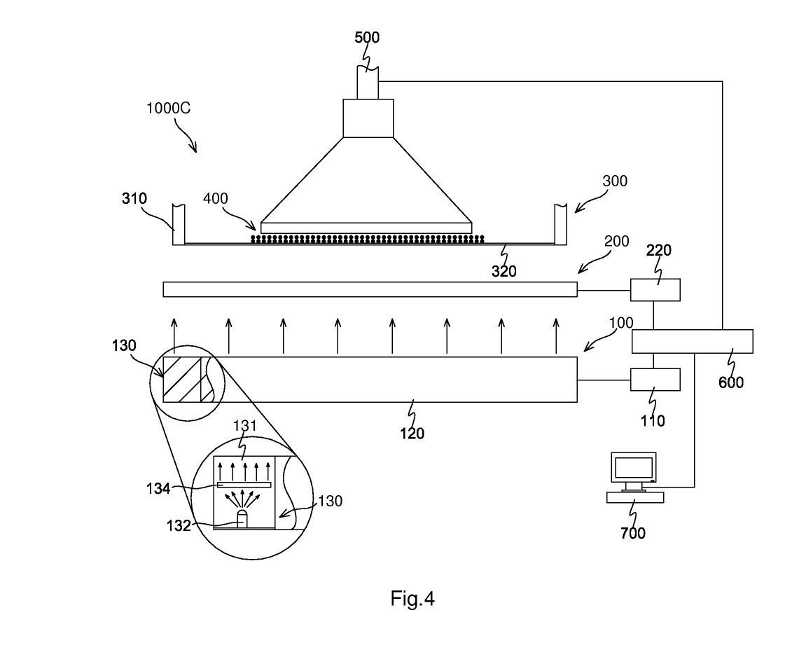

As shown in FIG. 4, which omits the same part shown in FIG. 3, in the fourth embodiment, the stereolithographic apparatus 1000C further comprises a elevator member 500, a controlling unit 600 and a computer 700. When the liquid photosensitive resin 400 in the container 300 has been cured and converted to a solid layer, the elevator member 500 raise the solid layer upward to form a predetermined gap between the solid layer and the remain resin 400. After newly added photosensitive resin filled into the gap, the elevator member 500 moves downward, positioned in a proper position, and then cure the newly added resin and convert it into the next solid layer. In this embodiment, the controlling unit 600 is electrically connected with the driving unit 220, controller 110 and the computer 700. In this embodiment, the computer 700 can control the light source device 100, the imaging means 200 and the elevator member 500 to work. The computer 700 may be an embedded chip. Moreover, the controlling unit 600, driving unit 220 and controller 110 may be integrated in a controlling chip.

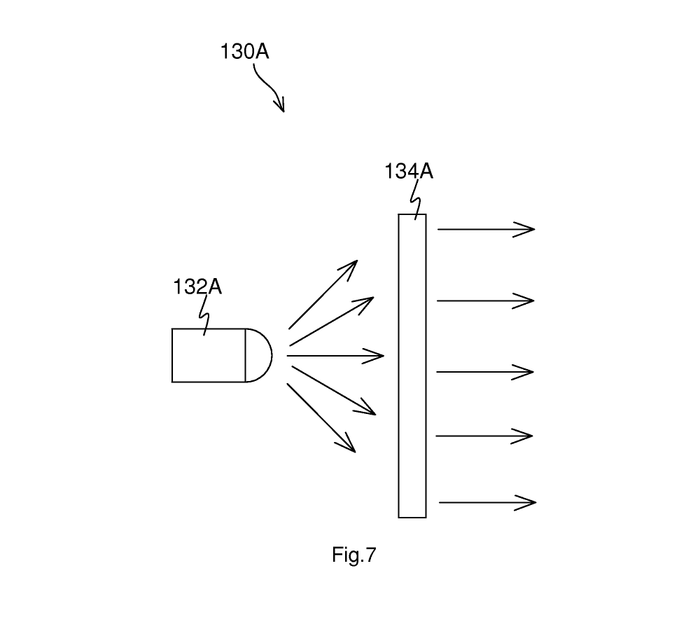

FIGS. 7-10 shows a plurality of examples of the light emitting unit. As shown in FIG. 7, the light emitting unit 130A comprises an emitter 132A and a lens 134A serving as a collimator. The lens 134A may be the convex lens or Fresnel lens, which can be obtained easily. The lens 134A may be disposed on a top of the compartment 131, which can convert the divergent light to substantially parallel light and provide a compact structure for industrialization.

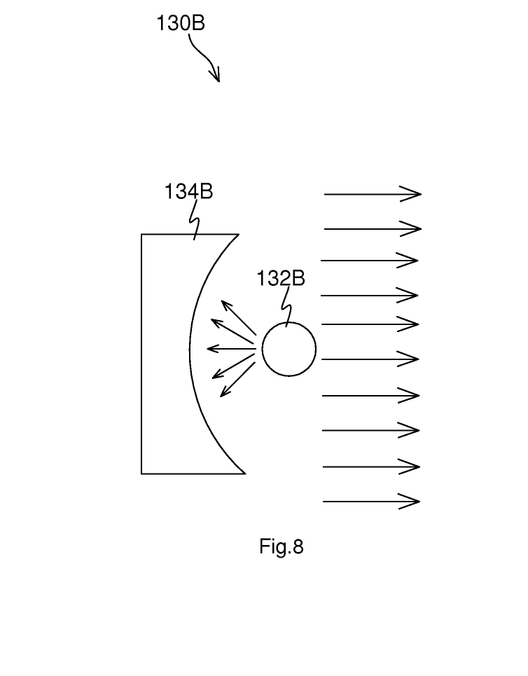

As shown in FIG. 8, the light emitting unit 130B comprises an emitter 132B and a reflector 134B serving as the collimator. The reflector 134B may be the concave mirror. The reflector 134B may be disposed rear of the emitter 132B along an optical path thereof, such as the mounting plate located on the bottom of the compartment 131. With such configuration, the light emitting unit can effectively convert the divergent light to substantially parallel light, and the stereolithographic apparatus can be minimized.

As shown in FIG. 9, light emitting unit 130C includes an emitter 132C, a reflector 133C, a lens 134C and a light shading member 136C. The combination of the reflector 133C, the lens 134C and the light shading member 136C serves as the collimator. In this embodiment, the reflector 133C may be the spherical reflector. The lens 134C may be the convex lens.

A window is formed in the centre of the light shading member 136C. For example, the light shading member 136C may be a fiber reinforced polymer that is capable of absorbing light. The emitter 132C, the reflector 133C, the lens 134C and the light shading member 136C are disposed in the compartment 131. With such configuration, the light emitting unit can effectively convert the divergent light to substantially parallel light for curing the photosensitive resin.

As shown in FIG. 9, the light shading member 136C each corresponding to one emitter 132C is disposed in the compartment 131. Alternatively, the light shading member 136C may be disposed outside the compartment 131, and one light shading member 136C corresponds to plurality of emitters 132C, or all of the emitters 132C.

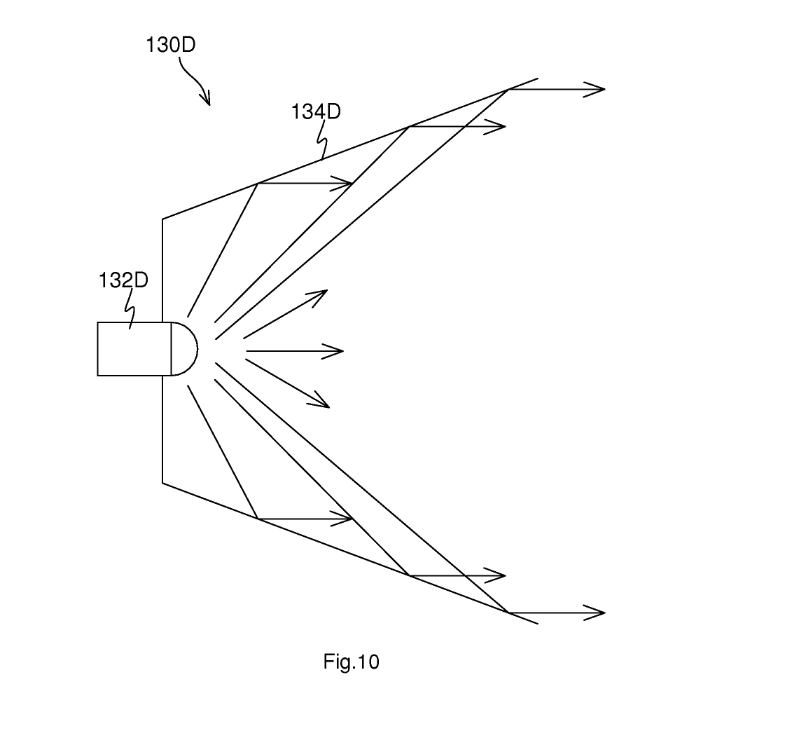

As shown in FIG. 10, the light emitting unit 130D comprises an emitter 132D and a reflector 134D serving as the collimator. Preferably, the reflector 134D may be a pyramidal plane reflector. The pyramidal plane reflector is attached on the inner wall of the compartment 131. For example, the inner wall of the compartment 131 may be pyramidal plane. Optionally, a reflecting film is coated on the inner wall of the compartment 131. With such configuration, the light emitting unit can effectively convert the divergent light to substantially parallel light for curing the liquid resin effectively, and the stereolithographic apparatus can be minimized.

Each of the light emitting units 130 includes a LED. A wavelength of light emitted by the light emitting unit 130 is ranged from 250 nm to 700 nm. Preferably, the wavelength of the light may be ranged from 350 nm to 500 nm. The light emitting unit 130 may be UV LED, blue LED, green LED, yellow LED, cyan LED, orange LED, red LED or white LED.

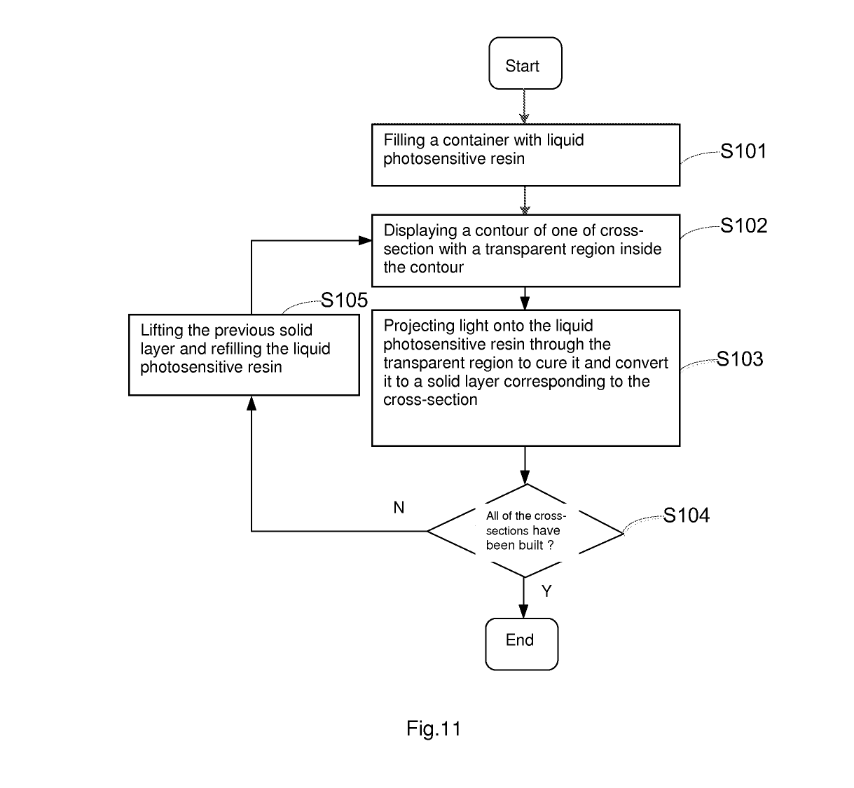

As shown in FIG. 11, a stereolithographic method using above- mentioned stereolithographic apparatus for producing an object having multiple cross-sections, the method comprises:

step 101: fill the photosensitive resin 400 into the container 300;

step 102: display the contour of one of the cross-sections on the imaging means 200 with a transparent region inside the contour;

step 103: the light emitting unit 130 emit light through the transparent region to cure the photosensitive resin 400 in the container 300 and convert it into a solid layer corresponding to the cross-section of the object;

step 104: determine all of the cross-sections have been built, if all of the cross-sections have been built, the process is completed; otherwise, execute the next step;

step 105: lift the previous solid layer, refill the liquid photosensitive resin and repeat the steps 102-104 to form the object. When the liquid photosensitive resin 400 in the container 300 has been cured and converted to a solid layer, the elevator member 500 lift the solid layer upward to form a predetermined gap between the solid layer and the remain resin 400. After newly added photosensitive resin filled into the gap, the elevator member 500 moves downward, positioned in a proper position, and then cure the newly added resin and convert it into the next solid layer.

The stereolithographic apparatus may be used to produce various two-dimensional objects or three-dimensional objects. The light system only has the light source device and the imaging means, which has the following advantages: simple position relationship, compact structure, less part, reduced dimension and manufacturing cost. Compared with the laser scanning system or the DLP projector, the cost of the imaging means in the illustrated embodiments is low, and the amount of material in the illustrated embodiments is reduced.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope.

What is claimed is:

1. A stereolithographic apparatus for producing an object, the apparatus comprising:
a container for containing liquid photosensitive resin;
an imaging means for displaying a contour of a two-dimensional image with a transparent region inside the contour; and
a light source device for projecting light onto a surface of the liquid photosensitive resin through the transparent region to cure the liquid photosensitive resin; wherein,
the imaging means is disposed between the container and the light source device;
the light source device is a area light source emitting substantially parallel light.

2. The stereolithographic apparatus of claim 1, wherein, the light source device comprises a plurality of light emitting units arranged in array.

3. The stereolithographic apparatus of claim 2, wherein, the light source device further comprises a light shading member located on optical paths of the light emitting units for absorbing stray light.

4. The stereolithographic apparatus of claim 2, wherein, the light source device further comprises a controller electrically connected with the light emitting units for controlling the light emitting units to be on or off.

5. The stereolithographic apparatus of claim 2, wherein, each light emitting unit comprises at least one emitter and a collimator that is configured for converting divergent light emitted by the emitter to substantially parallel light.

6. The stereolithographic apparatus of claim 5, wherein, the collimator is a reflector or a lens.

7. The stereolithographic apparatus of claim 6, wherein, the collimator is a concave mirror, a spherical reflector, a convex lens or a Fresnel lens.

8. The stereolithographic apparatus of claim 1, wherein, the imaging means is a monochrome TFT liquid crystal display or a colored TFT liquid crystal display.

9. The stereolithographic apparatus of claim 1, wherein, each light emitting unit comprises a LED, and a wavelength of light emitted by the light emitting unit ranged from 250 nm to 700 nm.

10. A stereolithographic method for producing an object having multiple cross-sections, the method comprising:
step 1: filling a container with liquid photosensitive resin;
step 2: displaying a contour of one of the cross-sections of the object on an imaging means with a transparent region inside the contour;
step 3: projecting light onto a surface of the liquid photosensitive resin through the transparent region by a light source device, which is a area light source emitting substantially panel light, to cure the liquid photosensitive resin and convert it to a solid layer corresponding to the cross-section of the object;
step 4: determining whether all of the cross-sections have been built, if all of the cross-sections have been built, the process completed; otherwise, executing the next step; and
step 5: lifting the previous solid layer, refilling the liquid photosensitive resin and repeating the steps 2-4 to form the object.

11. A stereolithographic apparatus, comprising:
a vat for holding liquid curable resin;
an imaging means for displaying a contour of a two-dimensional image with a transparent region inside the contour;
a light source device for projecting light onto a surface of the liquid photosensitive resin through the transparent region to cure the liquid curable resin;
an elevator means for raising and lowering the cured resin; and
a controlling unit for controlling the elevator means, the imaging means and the light source device to work; wherein,
the imaging means is disposed between the vat and the light source device; the elevator means moves with respect to the vat; the controlling unit is electrically connected with the imaging means and the light source device; and
the light source device emits substantially parallel light.

12. The stereolithographic apparatus of claim 11, wherein, the light source device comprises a plurality of light emitting units arranged in array.

13. The stereolithographic apparatus of claim 12, wherein, the light source device further comprises a light shading member located on optical paths of the light emitting units for absorbing stray light.

14. The stereolithographic apparatus of claim 12, wherein, the light source device further comprises a controller electrically connected with the light emitting units for controlling the light emitting units to be on or off.

15. The stereolithographic apparatus of claim 12, wherein, each light emitting unit comprises at least one emitter and a collimator that is configured for converting divergent light emitted by the emitter to substantially parallel light.

16. The stereolithographic apparatus of claim 15, wherein, the collimator is a reflector or a lens.

17. The stereolithographic apparatus of claim 16, wherein, the collimator is a concave mirror, a spherical reflector, a convex lens or a Fresnel lens.

18. The stereolithographic apparatus of claim 17, wherein, the imaging means is a monochrome TFT liquid crystal display or a colored TFT liquid crystal display.

19. The stereolithographic apparatus of claim 11, wherein, each light emitting unit comprises a LED, and a wavelength of light emitted by the light emitting unit ranged from 250 nm to 700 nm.

20. The stereolithographic apparatus of claim 11, wherein, each light emitting unit comprises a LED, and a wavelength of light emitted by the light emitting unit ranged from 350 nm to 500 nm.
